(19) United States
(12) Patent Application Publication
(10) Pub. No.: US 2025/0391095 A1
(43) Pub. Date: Dec. 25, 2025

(54) DUAL USE OF BOUNDING VOLUME HIEARCHY FOR RAY TRACING AND COLLISION DETECTION

(71) Applicant: Advanced Micro Devices, Inc., Santa Clara, CA (US)

(72) Inventor: Carsten Benthin, Munich (DE)

(73) Assignee: Advanced Micro Devices, Inc., Santa Clara, CA (US)

(21) Appl. No.: 18/750,098

(22) Filed: Jun. 21, 2024

(51) Int. Cl. G06T 15/06; G06T 17/00

(52) U.S. Cl. CPC G06T 15/06; G06T 17/005; G06T 2210/12; G06T 2210/21

(57) ABSTRACT

Techniques herein propose utilization of the bounding volume hierarchy generated for ray tracing for the purposes of collision detection. In various examples, once an application has requested ray tracing operations be performed, thus resulting in building of a bounding volume hierarchy (“BVH”), the application also requests collision detection to be performed with that BVH. Such requests can be made to a driver, for example, which causes the collision detection tests to be performed using the previously generated BVH (for example, on the central processing unit (“CPU”) or on a graphics processing unit). This double use of the BVH provides efficiencies as compared with having completely separate rendering and collision detection operations.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates an example oriented bounding box;

FIG. 6 illustrates operations performing using a BVH that includes one or more oriented bounding boxes, according to an example;

FIG. 7 illustrates a BVH including a top-level BVH and a plurality of bottom-level BVHs, according to an example;

FIG. 8 illustrates example two-phase collision detection tests; and

FIG. 9 is a flow diagram of a method for performing rendering and collision detection operations, according to an example.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy. Such a structure has a hierarchy of levels, where each level can include bounding volumes that bound the geometry of lower levels. Further, the bounding volumes can be “oriented,” meaning not aligned with the axes of the coordinate system.

Such bounding volume hierarchies are also beneficial for collision detection operations. For instance, it is possible to eliminate portions of a scene from consideration for collision detection by determining that an ancestor node of a set of geometry does not intersect with an object, and thereby to reduce the amount of work that needs to be done.

For this reason, techniques herein propose utilization of the bounding volume hierarchy generated for ray tracing for the purposes of collision detection. In various examples, once an application has requested ray tracing operations be performed, thus resulting in building of a bounding volume hierarchy (“BVH”), the application also requests collision detection to be performed with that BVH. Such requests can be made to a driver, for example, which causes the collision detection tests to be performed using the previously generated BVH (for example, on the central processing unit (“CPU”) or on a graphics processing unit).

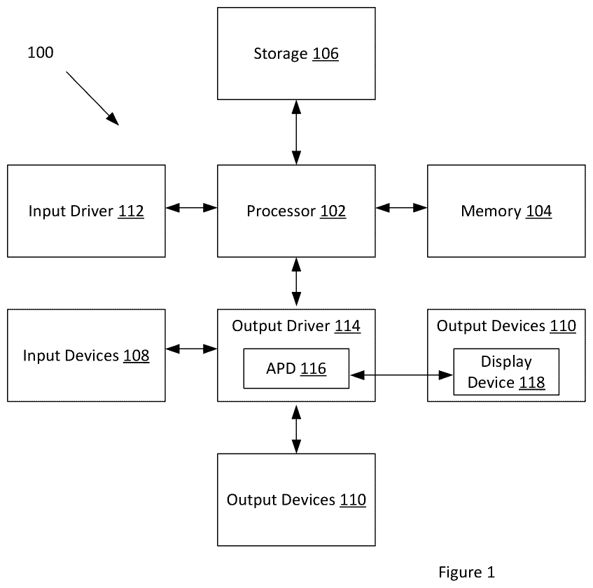

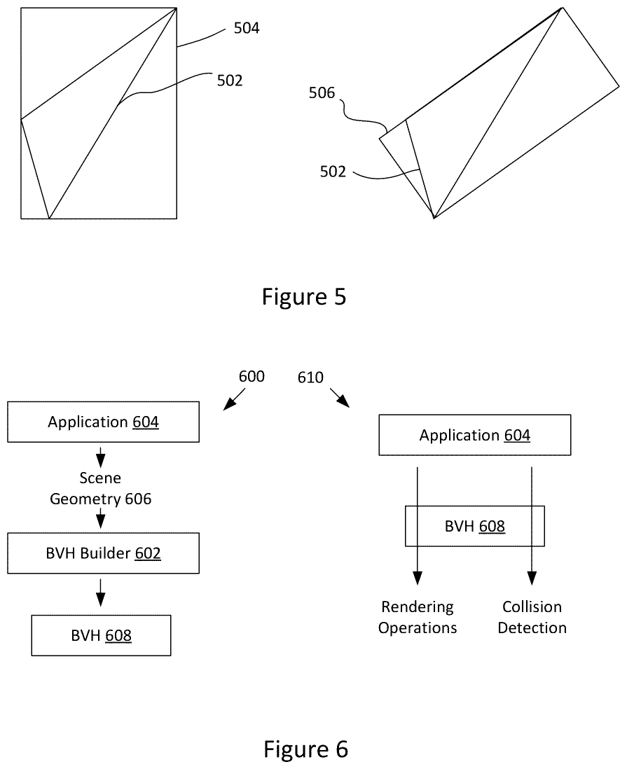

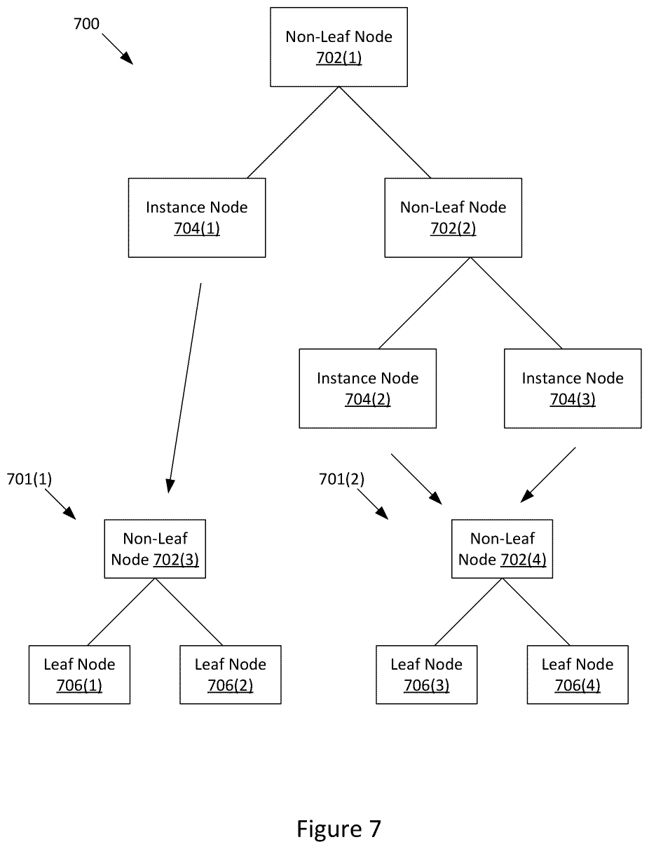

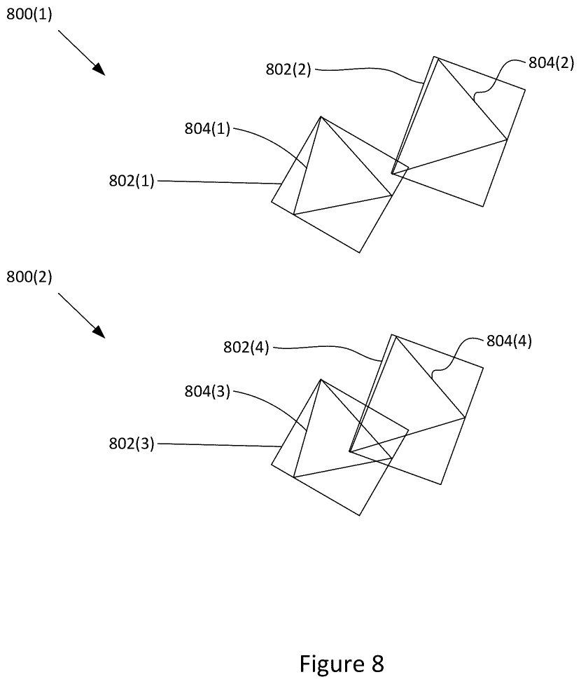

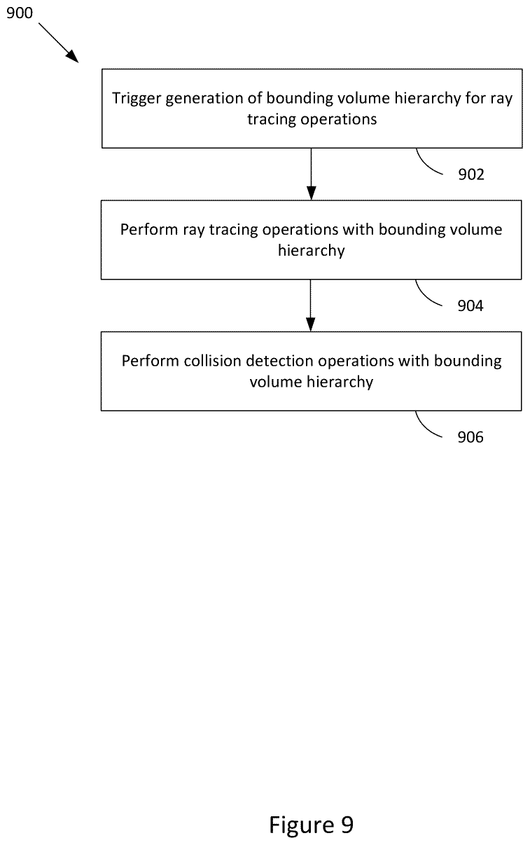

In the present disclosure, FIGS. 1-4 provide background for ray tracing. FIG. 5 illustrates oriented bounding boxes. FIG. 6 illustrates operations for use of the same BVH for both ray tracing and collision detection. FIG. 7 illustrates instance nodes in a BVH. FIG. 8 illustrates collision detection operations. FIG. 9 illustrates a flow for performing ray tracing and collision detection operations.

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

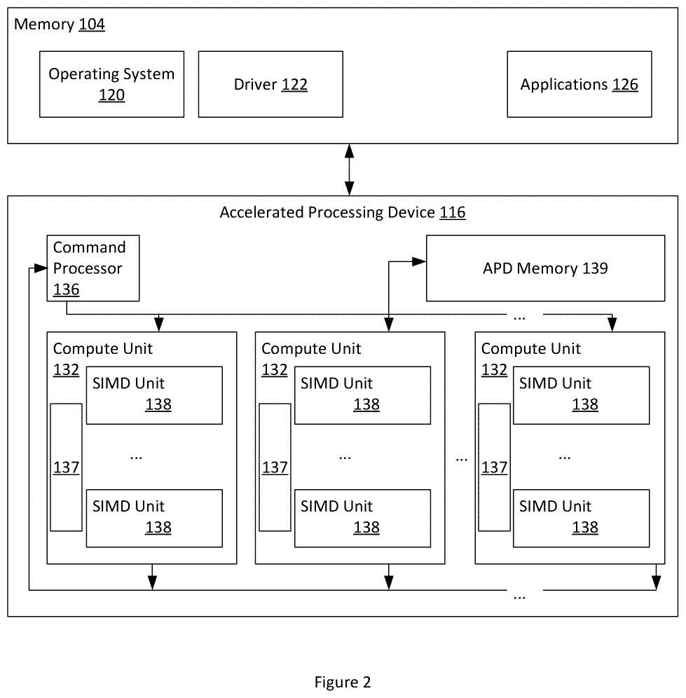

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The compute units 132 are sometimes referred to as “parallel processing units 202” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more three dimensional (3D) objects, divide images into a plurality of tiles, execute a visibility pass for primitives of an image, divide the image into tiles, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass.

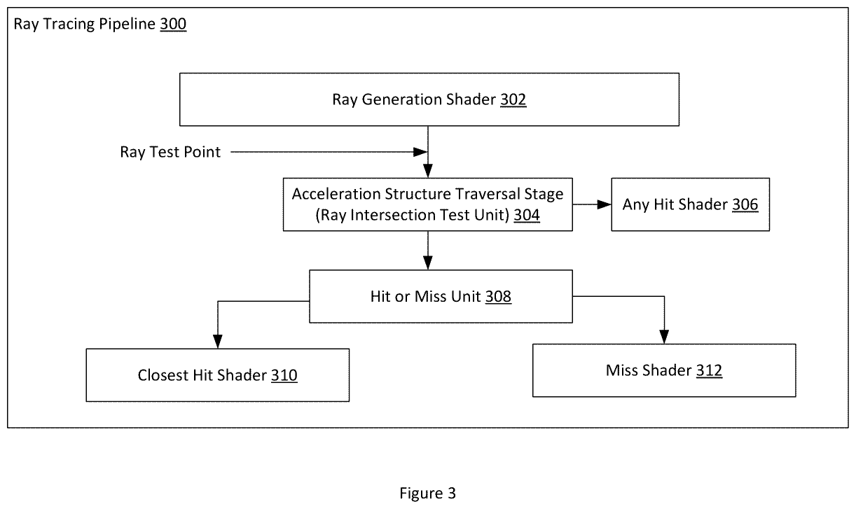

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

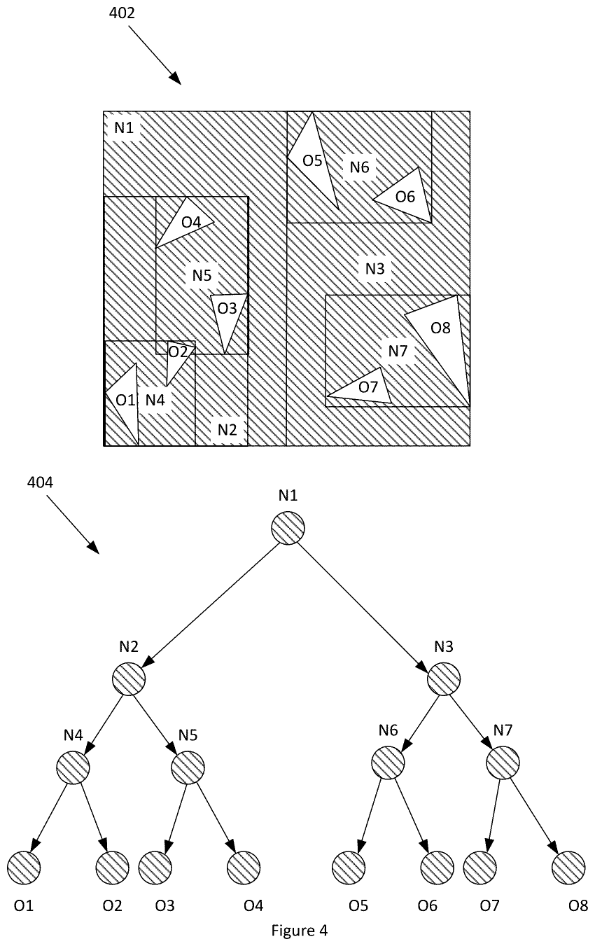

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

As described above, non-leaf nodes (e.g., nodes labeled “N”) of a bounding volume hierarchy include a bounding volume that bounds the contents of the descendants of that non-leaf node (which are called “underlying geometry”). A simple implementation uses axis-aligned bounding boxes as these bounding volumes, where the faces of such bounding boxes are parallel with the axes (e.g., x, y, and z) of the coordinate space. However, it is advantageous to use oriented bounding boxes, which are bounding boxes having faces that are not necessarily aligned with the axes.

FIG. 5 illustrates an example oriented bounding box. More specifically, FIG. 5 illustrates a comparison between an axis-aligned bounding box 504 and an oriented bounding box 506, both of which bound example underlying geometry of one triangle 502. With the axis-aligned bounding box 504, that bounding box bounds the triangle 502, but has a considerable amount of empty space (the space outside of the triangle 502 but within the box 504). This empty space can be considered inefficient, because rays that intersect the box within that empty space will cause the ray tracing pipeline 300 to further traverse the descendants of the associated non-leaf node, but will ultimately result in no intersection for any such descendant. An intersection with a bounding box that does not intersect any underlying geometry is sometimes referred to herein as a “false positive.” Because the role of a non-leaf node is to eliminate geometry from consideration as early as possible, bounding volumes with a considerable amount of empty space are considered inefficient. By orienting bounding boxes, as shown with oriented bounding box 506, the bounding volumes can be made to more tightly fit the underlying geometry, resulting in fewer false positives and thus more efficient operation. In various examples, a bounding volume hierarchy includes oriented bounding boxes as appropriate to reduce the false positives that would occur with exclusive use of axis-aligned bounding boxes during ray tracing.

FIG. 6 illustrates operations performing using a BVH that includes one or more oriented bounding boxes, according to an example. While it is possible to use a BVH including oriented bounding boxes to perform rendering operations with ray tracing, it is also possible to use such bounding volume hierarchies to perform collision detection operations.

Operation 600 involves a BVH builder 602 accepting scene geometry 606 from an entity (such as an application 604). The BVH builder 602 generates a BVH 608 for the scene geometry 606. There are many possible ways for generating a BVH 608. Some of these ways include top-down BVH builds, which generate a root node and iteratively divide geometry of the scene to create levels in the BVH in a top-down manner, and bottom-up BVH builds, which start with leaf node geometry and group that geometry into nodes to create levels in a bottom-up manner. A simple example includes linear BVH (“LBVH”), which first calculates Morton codes for primitives (e.g., triangles) and sorts the primitives by the Morton codes. To generate a higher level directly above a lower level, the LBVH algorithm groups adjacent primitives in the lower level to form nodes of the higher level. The LBVH algorithm repeatedly performs these actions. Many other types of bottom-up BVH build algorithms are possible. A simple example for a top-down builder includes beginning with a root node that includes all geometry of the scene. Then, through a division function, the BVH builder divides that geometry to form children of the root node. The division function can divide the children in any technically feasible manner, such as by selecting a division plane and placing the triangles on the same side of the plane in the same node. The BVH builder repeats these steps until some termination condition is met, such as all leaf nodes having at most a maximum number of primitives.

In some examples, the BVH builder 602 generates a two-level BVH. A two-level BVH has a top level BVH that includes pointers to one or more bottom-level BVHs, as well as one or more bottom-level BVHs. Generally, a bottom-level BVH is a representation of geometry referred to as an “instance,” which can be repeated through the BVH with certain changes referred to as “an instance transform” (e.g., transformations such as scaling, rotation, and translation). The nodes in the top-level BVH that include pointers to bottom-level BVHs are called instance nodes and either store or are associated with an instance transform. Use of instances in this manner helps reduce the total amount of data needed to represent a BVH, since instances can reuse the mesh information of a single object multiple times and can even accommodate changes through the instance transform. In some examples, the BVH builder 602 includes indications from the application 604 regarding which portions of the scene geometry 606 are representable as instances, as well as the transforms to be applied. In an example, the scene geometry 606 includes a plurality of similar objects and therefore includes a mesh for an instance as well as a plurality of instance transforms that each represents a different instance of the object, transformed to a particular position, scale, and/or rotation. The BVH builder 602 builds the top-level BVH to include instances nodes that point to such instances as leaf nodes, and also builds bottom-level BVHs for the instances. As a result, for at least one bottom-level BVH, multiple instance nodes of the top-level BVH refer to that single bottom-level BVH, but with different instance transforms.

The BVH builder 602 is implemented in technically feasible manner. In some examples, the BVH builder 602 is software executed on one or more processors, hardware, such as fixed-function or programmable processors, or is embodied in any other technically feasible manner. In some examples, the BVH builder 602 includes a portion of the driver 122 and one or more shader programs that the driver 122 causes to execute on the compute units 132. In some examples, a combination of the driver 122 and shader programs perform the functionality of the BVH builder 602. In some such examples, the driver 122 accepts the scene geometry 606 and spawns shader programs to generate the BVH 608 based on the geometry. In some examples, the shader programs use hardware acceleration for one or more aspects of building the BVH 608.

FIG. 6 also illustrates BVH-use operations 610. In these operations, the application 604 uses the BVH 608 both for rendering (e.g., ray tracing) and for collision detection. More specifically, the application 604 performs rendering with the BVH 608, requesting the APD 116 to perform ray tracing operations as described elsewhere herein (for example, spawning rays that the APD 116 traverses the BVH 608 with, where such traversal results in execution of one or more shaders based on intersection results). In addition, the application 604 triggers collision detection operations based on the contents of the BVH 608. More specifically, the BVH 608 describes geometry in a way that is conducive to collision detection operations. Collision detection operations include queries that request some aspect of whether two (or more) objects intersect with each other. Collision detection operations are useful for many types of systems such as video games (in which it is needed to know whether two game objects collide), physics simulations, robotics, and other areas.

One technique for performing collision detection is a two-phase technique. In the first phase, the bounding volume of two objects are tested for intersection and if there is no intersection, it is determined with certainty that the two objects do not intersect. If there is an intersection, then in a second phase, the collision detection engine performs a finer check, checking the meshes of the two objects for intersection. This two-phase technique has the benefit that a relatively inexpensive operation—testing two bounding boxes for intersection—can be used to eliminate a large number of more detailed intersection tests from being performed, which improves processing efficiency.

In some examples, the driver 122 performs collision detection using the BVH 608. In other examples, the application 604 itself, executing on the processor 102 (e.g., CPU) performs collision detection using the BVH 608. In some examples, the application 604 and/or driver 122 causes the APD 116 to execute shader programs that perform collision detection.

Regarding using the BVH 608, as described above, the first phase of collision detection involves identifying one or more pairs of bounding boxes that intersect each other. The BVH 608 is well-suited for this purpose, as it already has bounding volumes that bound underlying geometry. Thus, in various examples, the application 604 causes collision detection to occur using the BVH 608 by determining whether two bounding volumes of the BVH 608 (e.g., of non-leaf nodes of the BVH 608) intersect. Each such bounding volume would be associated with a particular “object.” Then, if two bounding volumes do intersect, the application 604 causes the second phase to occur, determining whether the underlying geometry (e.g., the mesh defined by the triangles that descend from the bounding volumes) intersect.

Importantly, the bounding volumes for various objects of the scene geometry 606 are already available as a result of the BVH builder 602 building the BVH 608. Thus, the collision detection operations gain advantage from operations already performed for other purposes (e.g., rendering using ray tracing). Thus, in some examples, the application 604 causes the BVH 608 to be generated for ray tracing and then causes collision detection to occur using that BVH. In some examples, at least some of the bounding volumes of such a BVH 608 are oriented, as described elsewhere herein, and this orientation provides benefits in terms of accuracy and a reducing in false positives for collision detection. For example, if an oriented bounding volume fits the underlying geometry better than an axis-aligned bounding box would, then there will be more false positives at the first phase of collision detection than if axis-aligned bounding boxes were used.

Above, it is stated that a first bounding volume of the BVH 602 could be tested for intersection with a second bounding volume of the BVH 602, and that such a test would identify, for the first phase, whether the underlying geometry (e.g., the primitives that are descendants of that bounding volume) of the first bounding volume intersects the underlying geometry of the second bounding volume. Thus, the application 604 requests the first phase of collision detection to be performed between objects, each of which includes a certain portion of the scene geometry, by requesting testing of intersection of two bounding volumes that bound each portion. In other words, each bounding volume of the BVH 608 bounds a certain portion of the scene geometry 606 represented in the BVH 602, and that portion can be considered an “object” for which collision detection can be performed. Thus, in some examples, the application 604 requests collision detection to be performed for two or more objects represented in the BVH 608 by specifying two or more such bounding volumes. In some examples, the application 604 specifies one bounding volume and requests an indication of which objects intersect the bounding volume.

In some examples, the “objects” in a bounding volume are limited to the instance nodes. In other words, in such examples, each instance node is associated with an object for which collision detection can be performed. Thus, in some examples, the application 604 performs collision detection requests for instance nodes. In some examples, the application 604 performs a query specifies one instance node and determines which other instance nodes intersect the specified instance node. In other examples, the application performs a query specifying two instance nodes and determines whether the two instance nodes intersect.

FIG. 7 illustrates a BVH including a top-level BVH 700 and a plurality of bottom-level BVHs 701, according to an example. Top-level BVHs 700 include non-leaf nodes 702 and instance nodes 704. Each instance node 704 points to a bottom-level BVH 701 and includes an instance transform. Each bottom-level BVH 701 includes one or more non-leaf nodes 702 and one or more leaf nodes 706.

As described elsewhere herein, in some examples, each instance node 704 is associated with an object in the scene. More specifically, by specifying a bottom-level BVH 701, the instance node 704 specifies a mesh for an object, and specifying an instance transform specifies additional modifications to that mesh that define an object. It should be understood that in this example, there is not a one-to-one correspondence between bottom-level BVHs 701 and objects, but there is a one-to-one correspondence between instance nodes 704 and objects.

In some examples, the application 604 triggers generation of a two-level BVH 700 that includes a top-level BVH 700 and one or more bottom-level BVHs 701. The BVH builder 602 builds such a BVH. The application 604 triggers rendering with ray tracing using the BVH and also triggers collision detection using that same BVH. In some such examples, the application 604 triggers execution of one or more collision detection queries. Each such query specifies one or more objects—which are uniquely associated with a particular instance node 704—and requests collision information for such one or more objects. Such requests can query whether a first object (e.g., a first instance node 704) collides with a second object (e.g., a second instance node 704), for the first phase of the collision detection test. Other requests can query which objects a first object (e.g., a first instance node 704) collides with.

In some examples, each instance node 704 of a BVH 700 is considered collidable and thus will be considered to collide with each other overlapping instance node 704 of the BVH 700 or scene. In other examples, each instance node 704 includes an indication (ultimately supplied by another source such as the application 604) of whether the instance node 704 is collidable. Objects can only collide with other collidable objects, so the query would only return positive (e.g., “yes, they have collided”) results for objects that both overlap and are marked as collidable. In such examples, the collision detection query will return a negative result for a query of a first object with a second object if the second object is not marked as collidable, even if the first object and the second object actually overlap. It should be understood that the collision detection operations described above are for the first phase of collision detection, where bounding volumes of two objects are tested for intersection with each other.

FIG. 8 illustrates example two-phase collision detection tests. In this example, an application 604 or other entity (e.g., processor 102 or APD 116) requests collision detection be performed for a first object 804(1) against a second object 804(2) (or alternatively, requests information indicating which objects 804 collide with the first object 804(1), and the second object is 804(2) is one such possible object). Each such object has a bounding volume 802 that is part of a BVH 608 created for the purpose of performing ray tracing operations. In a first collision detection operation 800(1), a first object 804(1) is tested for intersection against a second object 804(2). The first object 804(1) has a first bounding volume 802(1) and the second object 804(2) has a second bounding volume 802(2). In some examples, the first object 804(1) corresponds to a portion of a BVH, where the portion includes geometry that descends from a non-leaf node (e.g., an instance node or not an instance node) associated with the bounding volume 802(1) and the second object is 804(2) corresponds to a different portion of the BVH, where the portion includes geometry that descends from a non-leaf node associated with the bounding volume 802(2). In other words, in some examples, each bounding volume 802 is associated with a node specifying that bounding volume (e.g., a non-leaf node or an instance node) and the object 804(1) correspond to one or more primitives of leaf nodes that ultimately descend from the node specifying the bounding volume.

In this example, the first phase of the collision detection algorithm determines that the two bounding volumes overlap. A second phase would determine that the two bounding volumes do not overlap.

A second operation 800(2) is similar to the first operation 800(1), with bounding volumes 802(3) and 802(4) and objects 804(3) and 804(4). Additionally, in the first phase of the collision detection operation, it is determined that the bounding volumes 802 overlap, and in the second phase of the collision detection operation, it is determined that the object 804 overlap.

FIG. 9 is a flow diagram of a method 900 for performing rendering and collision detection operations, according to an example. Although described with respect to the system of FIGS. 1-8, those of skill in the art will recognize that any system configured to perform the steps of the method 900 in any technically feasible order falls within the scope of the present disclosure.

In the following description, the steps of the method 900 are described as being performed by “an application 604.” In various examples, such steps are performed by software executing on the processor 102, software (such as a shader program) executing on the APD 116, hardware (such as any processor, any component of the processor 102, or any component of the APD 116, where “hardware” refers to circuitry), or any combination thereof. Each step may be performed by the same entity or a different entity, which together are referred to as the “application.”

At step 902, the application 604, a shader program, the device driver 122, the processor 102, or the APD 116 requests generation of a bounding volume hierarchy for ray tracing operations. In some examples, this request is an explicit request, where the application 604 instructs the driver 122 to generate a BVH based on provided scene geometry. In other examples, the request is implicit, with the application 604 providing scene geometry to the driver 122 and the driver 122 automatically generating a BVH from that scene geometry, as such generation is necessary for ray tracing operations.

The device driver 122 generates the BVH in any technically feasible manner, such as in a top-down manner or in a bottom-up manner, or in any other technically feasible manner. In a top-down BVH build, the BVH builder 602 selects, from a set of nodes being considered, a node, and subdivides that node to form child nodes. Subdivision occurs by designating the children of that node as belonging to one of the subdivision (e.g., in a geometric manner, such as by determining which side of a division plane each child node falls on). Each newly created node is placed into the set of nodes being considered unless than node has reached a termination criterion (e.g., there are too few primitives in that node). It is possible to specify that instances are included in the scene geometry, in which case the top level BVH build will terminate when it generates a node corresponding to an instance node (e.g., when a node include all instance geometry and nothing else is generated). In such examples, the BVH builder will also build the instance nodes in a similar manner. In a bottom-up BVH build, a BVH builder 602 begins with a sorted list of primitives at a bottom level and combines those primitives into non-leaf nodes to form the next higher level. The bottom-up BVH build continues until a single node—the root node—is generated. A bottom-up procedure can be used for the situations in which instance nodes are used as well.

At step 904, the APD 116 performs ray tracing operations using the bounding volume hierarchy. Specifically, the APD 116 performs rendering operations by generating rays and casting the rays against scene geometry represented by the generated BVH. In some examples, these rendering operations include determining which geometry the rays intersect with, executing shaders based on such determining, and generating colors and other outputs for pixels for a render target.

At step 906, the processor 102 and/or APD 116 performs collision detection operations with the bounding volume hierarchy. In some examples, the collision detection operations are performed at the request of an application 604 or other software or hardware. In some examples, the collision detection operations specified request determining which objects intersect with a specified object. In other examples, the collision detection operations specified request determining whether two objects collide. In some examples, the collision detection operations benefit from the BVH being already generated, as the BVH hierarchical structure is helpful for performing collision detection. In some examples, the hierarchical structure is useful because it allows for early elimination of consideration of large portions of the scene. More specifically, two objects of the scene cannot intersect if the bounding volumes of their ancestors do not intersect. Thus, it is possible to quickly eliminate a portion of the BVH from consideration for collision detection by testing two bounding volumes for intersection with each other. In an example, a collision detection request is made to determine which objects of a scene intersect a first object of the scene. The driver 122 (or other entity performing the collision detection request) tests bounding volumes for nodes of the BVH against the bounding volume of the first object and for the bounding volumes that do not intersect the bounding volume of the first object, eliminates all descendants of such bounding volumes from consideration. For bounding volumes that do intersect, the driver 122 or other entity tests the children of that box for intersection, eliminating such children whose bounding volumes do not intersect the first object, and so on, until determining for all objects either that they do not intersect the first object or that they do intersect. Aside from having an easily available BVH for these operations, the driver 122 has also constructed oriented bounding boxes for nodes of the BVH, which is a time-consuming operation and provides additional fidelity for the collision detection operations.

In some examples, the driver 122 performs, or causes to be performed (e.g., by spawning shader programs to execute on the APD 116) techniques for collision detection between oriented bounding boxes. In an example, these techniques utilize the separating axis theorem. The separating axis theorem states that if there is any axis along which the projection of two objects do not overlap, then the two objects do not overlap. Further, the axes to test are defined by the normals of the faces of the two objects.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310, miss shader 312, or BVH builder 602 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
generating a bounding volume hierarchy for scene geometry;
performing ray tracing operations using the bounding volume hierarchy; and
performing collision detection operations with the bounding volume hierarchy.

2. The method of claim 1, wherein the bounding volume hierarchy includes one or more oriented bounding boxes.

3. The method of claim 2, wherein the collision detection operations comprise determining whether two or more oriented bounding boxes intersect.

4. The method of claim 1, wherein the collision detection operations comprise a first phase of a two phase collision detection operation, wherein in the first phase, bounding boxes are tested for intersection and in a second phase of the two phase collision detection operation, meshes bounded by the bounding boxes are tested for intersection.

5. The method of claim 1, wherein the collision detection operations include determining whether bounding volumes of the bounding volume hierarchy overlap.

6. The method of claim 1, wherein the ray tracing operations comprise testing one or more rays for intersection against geometry represented in the bounding volume hierarchy.

7. The method of claim 1, wherein the bounding volume hierarchy includes one or more instance nodes.

8. The method of claim 7, wherein the collision detection operations comprise determining whether an instance node intersects with another instance node.

9. The method of claim 8, wherein one or more instance node is marked as collidable.

10. A system comprising:
a memory configured to store scene geometry; and
a processor configured to perform operations including:
generating a bounding volume hierarchy for scene geometry;
performing ray tracing operations using the bounding volume hierarchy; and
performing collision detection operations with the bounding volume hierarchy.

11. The system of claim 10, wherein the bounding volume hierarchy includes one or more oriented bounding boxes.

12. The system of claim 11, wherein the collision detection operations comprise determining whether two or more oriented bounding boxes intersect.

13. The system of claim 10, wherein the collision detection operations comprise a first phase of a two phase collision detection operation, wherein in the first phase, bounding boxes are tested for intersection and in a second phase of the two phase collision detection operation, meshes bounded by the bounding boxes are tested for intersection.

14. The system of claim 10, wherein the collision detection operations include determining whether bounding volumes of the bounding volume hierarchy overlap.

15. The system of claim 10, wherein the ray tracing operations comprise testing one or more rays for intersection against geometry represented in the bounding volume hierarchy.

16. The system of claim 10, wherein the bounding volume hierarchy includes one or more instance nodes.

17. The system of claim 16, wherein the collision detection operations comprise determining whether an instance node intersects with another instance node.

18. The system of claim 17, wherein one or more instance node is marked as collidable.

19. A non-transitory computer-readable medium storing instructions that, when executed by a processor, cause the processor to perform operations comprising:
generating a bounding volume hierarchy for scene geometry;
performing ray tracing operations using the bounding volume hierarchy; and
performing collision detection operations with the bounding volume hierarchy.

20. The non-transitory computer-readable medium of claim 19, wherein the bounding volume hierarchy includes one or more oriented bounding boxes.
